(19) United States
(12) Patent Application Publication
(10) Pub. No.: US 2026/0338121 A1
(43) Pub. Date: Oct. 29, 2026

(54) COVER FOR THROTTLE DEVICE

(71) Applicant: AISAN KOGYO KABUSHIKI KAISHA, Obu-shi (JP)

(72) Inventors: Yuto NARITA, Kariya-shi (JP); Shinsuke MATSUYAMA, Nagoya-shi (JP); Eisuke BABA, Kasugai-shi (JP)

(73) Assignee: AISAN KOGYO KABUSHIKI KAISHA, Obu-shi (JP)

(21) Appl. No.: 19/654,837

(22) Filed: Apr. 22, 2026

(30) Foreign Application Priority Data
Apr. 24, 2025 (JP) 2025-072163

(51) Int. Cl. F02D 9/10

(52) U.S. Cl. CPC F02D 9/1035

(57) ABSTRACT

A cover for a throttle device provided in an intake passage of an internal combustion engine system includes a cover connector configured to be connected to a harness connector of the internal combustion engine system. The cover further includes a direction-variable mechanism connecting the cover connector to the cover. The direction-variable mechanism is configured to change the orientation of the cover connector with respect to the cover.

### CROSS-REFERENCE TO RELATED APPLICATIONS

This application claims priority to Japanese patent application serial number 2025-072163, filed Apr. 24, 2025, which is incorporated herein by reference in its entirety for all purposes.

### STATEMENT REGARDING FEDERALLY SPONSORED RESEARCH OR DEVELOPMENT

Not applicable.

### BACKGROUND

The present disclosure relates to a cover for a throttle device provided in an intake passage of an internal combustion engine system.

An internal combustion engine system mounted on a vehicle includes an intake passage that guides ambient air to the engine. The passage is provided with the throttle device configured to control the opening degree of the passage. The throttle device includes a housing with an opening, and a cover configured to close the opening. The housing defines a cylindrical air passage that constitutes part of the intake passage. A throttle valve is rotatably disposed within the air passage and is configured to rotate based on the amount of accelerator pedal input to control the opening degree of the air passage. The throttle device includes a throttle gear, and a motor that is configured to rotate the throttle valve via the throttle gear. The throttle device also includes a valve opening detection device for detecting the opening degree of the throttle valve. The throttle gear and the motor are accommodated within the housing through the opening of the housing. The opening is closed with the cover that is provided with the valve opening detection device and a cover connector. A harness connector of a harness that connects various components of the internal combustion engine system, such as devices, sensors, and actuators, is connected to the cover connector provided on the cover for the throttle device.

When an internal combustion engine system is mounted on a vehicle, the internal combustion engine system may be disposed in a narrow engine room such that various devices are adjacent to the throttle device. In such a situation, when the orientation of the cover connector is not adjustable, connecting the harness connector to the cover connector can become difficult. Therefore, there is a need for an improved cover for a throttle device.

### SUMMARY OF THE INVENTION

In one aspect of this disclosure, a cover for a throttle device provided in an intake passage of an internal combustion engine system includes a cover connector configured to be connected to a harness connector of the internal combustion engine system. The cover further includes a direction-variable mechanism connecting the cover connector to the cover. The direction-variable mechanism is configured to change an orientation of the cover connector with respect to the cover.

### BRIEF DESCRIPTION OF THE DRAWINGS

FIG. 1 is a perspective view of a throttle device according to one embodiment.

FIG. 2 is a side view of the throttle device shown in FIG. 1, as viewed in the direction of arrow II in FIG. 1.

FIG. 3 is a cross-sectional view of the throttle device, taken along line III-III of FIG. 2.

FIG. 4 is a perspective view of the outer side of the cover with a ball joint and a cover connector attached thereto.

FIG. 5 is a perspective view of the inner side of the cover of FIG. 4.

FIG. 6 is a side view of the cover of FIG. 5.

FIG. 7 is a front view of the ball joint of FIG. 4.

FIG. 8 is a cross-sectional view of the ball joint, taken along line VIII-VIII of FIG. 7.

FIG. 9 is a perspective view of the ball joint of FIG. 7.

FIG. 10 is an exploded perspective view of the cover connector of FIG. 4 with a base connector and two conversion connectors of different types shown separated from one another.

FIG. 11 is a schematic side view of a throttle device according to another embodiment having a pivot base and a pivot shaft member.

### DETAILED DESCRIPTION

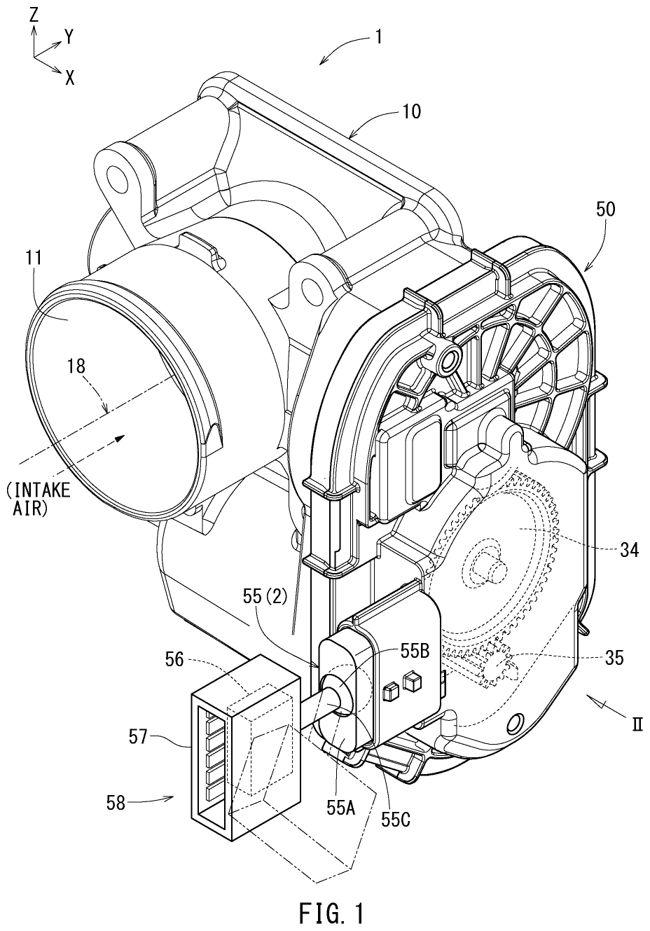

Embodiments of the present disclosure will be described with reference to the accompanying drawings. FIGS. 1 to 3 show a throttle device 1 that is configured to be provided in an intake passage of an internal combustion engine system for a vehicle. The throttle device 1 is configured to control the opening degree of the intake passage. Since vehicles vary widely depending on country, region, and intended use, the throttle device 1 mounted on the vehicle may be adjacent to various devices.

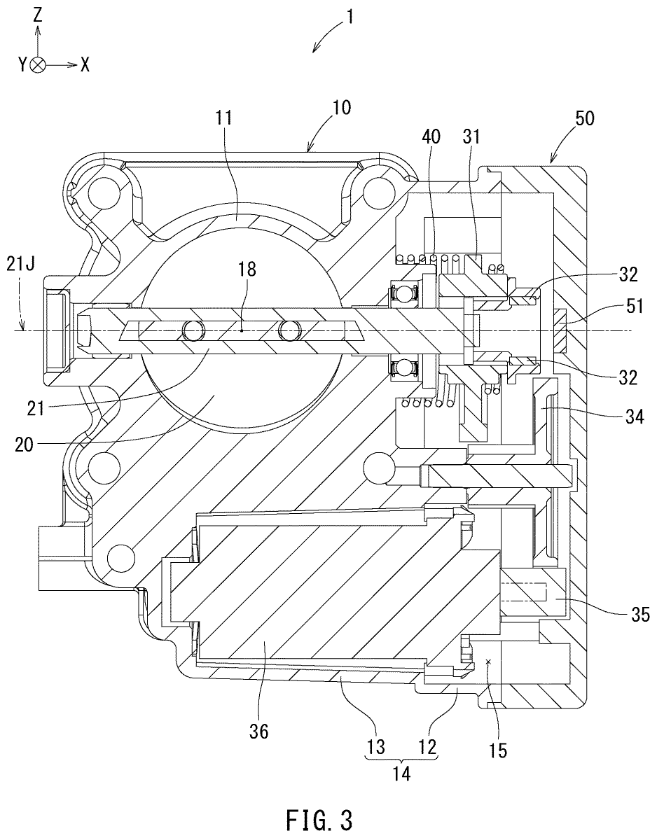

The throttle device 1 has a substantially cylindrical air passage 11 that constitutes part of the intake passage of the internal combustion engine system. As shown in FIGS. 1 to 3, the throttle device 1 includes a housing 10, a cover 50, a spring 40, a throttle valve 20, a shaft 21, a throttle gear 31, a magnetic circuit unit 32, an intermediate gear 34, a drive gear 35, and a motor 36. As shown in FIG. 3, the housing 10 is integrally molded to have a drive system accommodation portion 14 and the air passage 11. The drive system accommodation portion 14 includes a gear housing 12 and a motor housing 13. An opening 15 of the drive system accommodation portion 14 is sealingly closed by the cover 50.

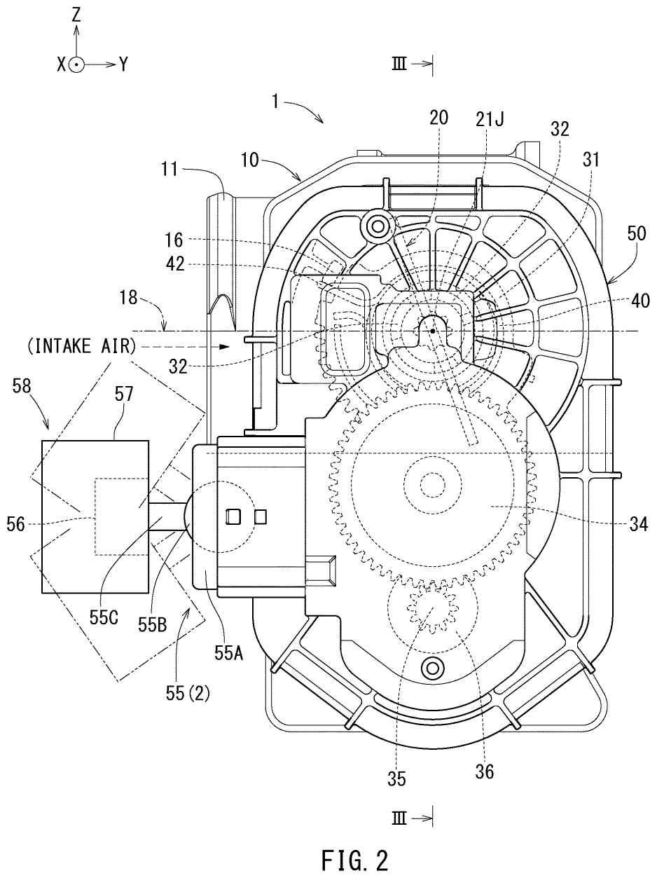

As shown in FIGS. 2 and 3, the throttle valve 20 has a substantially disk shape and is disposed within the air passage 11 of the housing 10. As shown in FIG. 3, the throttle valve 20 is secured to the shaft 21 extending across the air passage 11. The shaft 21 is rotatably supported by bearings in the housing 10. The throttle valve 20 is configured to rotate from a fully closed position to a fully open position within the air passage 11. This arrangement allows the throttle valve 20 to adjust the opening degree of the air passage 11 for controlling the flow rate of intake air through the air passage 11.

As shown in FIGS. 1 to 3, the throttle device 1 includes the motor 36, the drive gear 35, the intermediate gear 34, and the throttle gear 31 collectively forming a drive device for rotating the throttle valve 20. The motor 36 is housed in the motor housing 13 of the housing 10. The throttle gear 31, the intermediate gear 34, and the drive gear 35 are housed in the gear housing 12. As shown in FIGS. 1 to 3, after accommodating the motor 36 and each gear, the cover 50 is assembled to the housing 10 to seal the opening 15. The throttle gear 31 is connected to the shaft 21 and rotates the throttle valve 20 together with the shaft 21.

As shown in FIG. 2, the spring 40 is arranged in the throttle device 1. When the motor 36 is not energized, an arm portion 42 of the spring 40 abuts a retreat driving stopper 16 provided on the housing 10. In this case, the opening degree of the throttle valve 20 is maintained at an opening degree that enables the vehicle to move in a limp-home mode. Although not shown or described in detail, the housing 10 includes a fully-closed stopper against which the throttle gear 31 abuts when the throttle valve 20 is in the fully closed position, and a fully-open stopper against which the throttle gear 31 abuts when the throttle valve 20 is in the fully open position.

As shown in FIG. 3, a magnetic detection unit 51, such as a Hall sensor or a magnetic sensor, is provided on the cover 50. The magnetic detection unit 51 is disposed in the throttle device 1 at a position adjacent to the magnetic circuit unit 32. The magnetic circuit unit 32 is joined to the throttle gear 31 and rotates integrally with the throttle gear 31. The magnetic detection unit 51 detects the relative rotation angle of the magnetic circuit unit 32 relative to the magnetic detection unit 51 in a non-contact manner.

A cover connector 58 is attached to the cover 50 via a direction-variable mechanism 2. In this embodiment, the direction-variable mechanism 2 consists of a ball joint 55. The cover connector 58 is configured such that its orientation and position relative to the cover 50 can be changed via the ball joint 55. The ball joint 55 includes a base portion 55A, a ball portion 55B, and a tubular portion 55C.

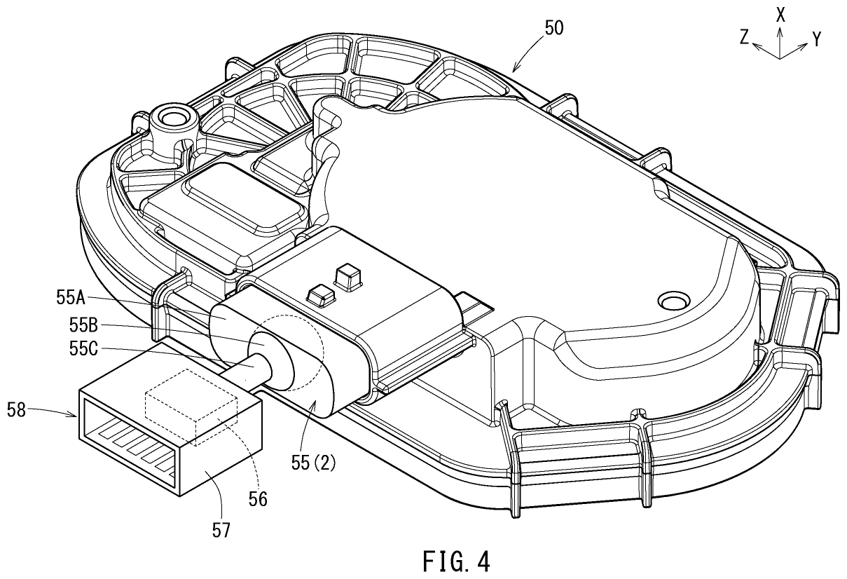

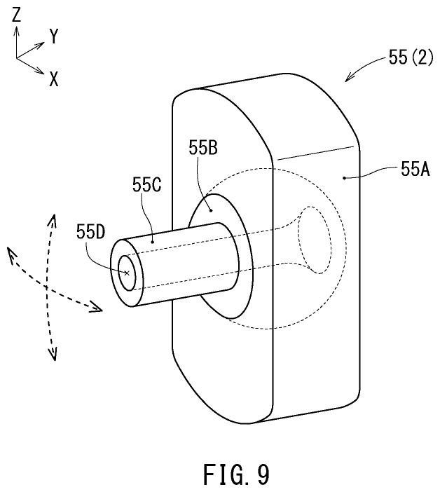

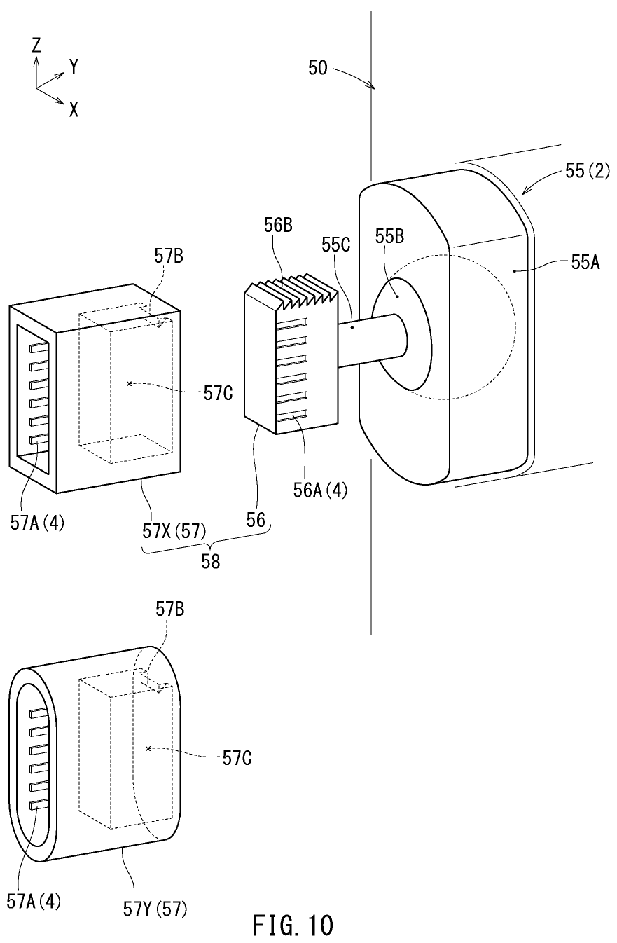

As shown in FIGS. 4 to 6, the base portion 55A of the ball joint 55 defines a substantially spherical recess for accommodating the ball portion 55B, and is fixed to the cover 50. As shown in FIGS. 8 and 9, the ball portion 55B has a substantially spherical shape and is rotatably supported by the base portion 55A. As shown in FIG. 10, one end of the tubular portion 55C is connected to the ball portion 55B. The other end of the tubular portion 55C is connected to a base connector 56. The base connector 56 is fitted to a conversion connector 57 such that the base connector 56 and the conversion connector 57 constitute the cover connector 58.

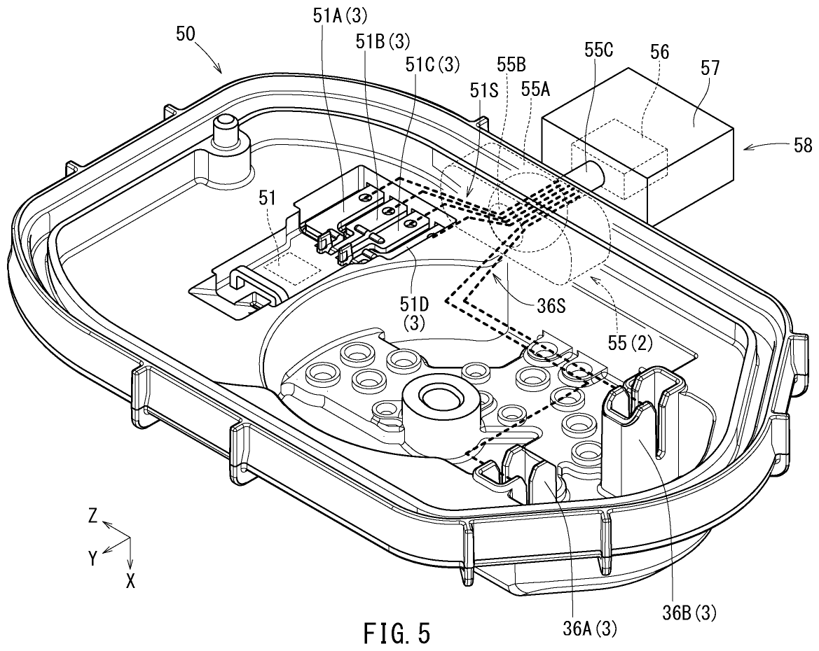

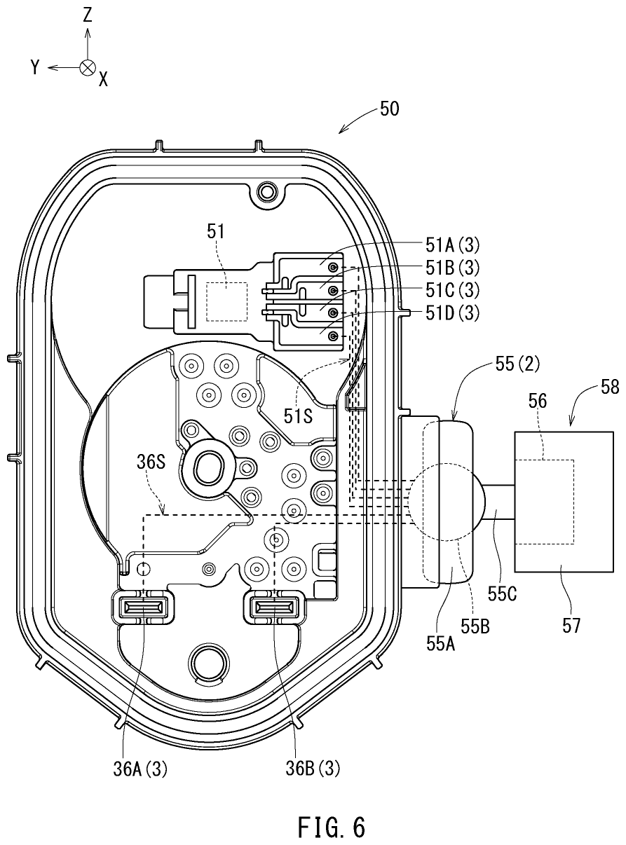

As shown in FIGS. 5 and 6, the cover 50 includes the magnetic detection unit 51, and magnetic detection terminals 51A to 51D. The magnetic detection terminals 51A to 51D are arranged in the vicinity of the magnetic detection unit 51 and are connected to the magnetic detection unit 51. The cover 50 includes motor terminals 36A and 36B, for supplying electric power to the motor 36. The motor terminals 36A and 36B are connected to base connector terminals 56A (see FIG. 10) of the base connector 56 via wires 36S. The magnetic detection terminals 51A to 51D are connected to the base connector terminals 56A via wires 51S. The wires 51S and 36S are accommodated within the cover 50 so as not to be exposed to the exterior or interior of the cover 50. For example, the cover 50 is composed of an outer cover and an inner cover such that the wires 51S and 36S are accommodated between the outer cover and the inner cover. The magnetic detection units 51 and the motor 36 are collectively referred to as electronic components. The magnetic detection terminals 51A to 51D and the motor terminals 36A and 36B are collectively referred to as in-cover terminals 3.

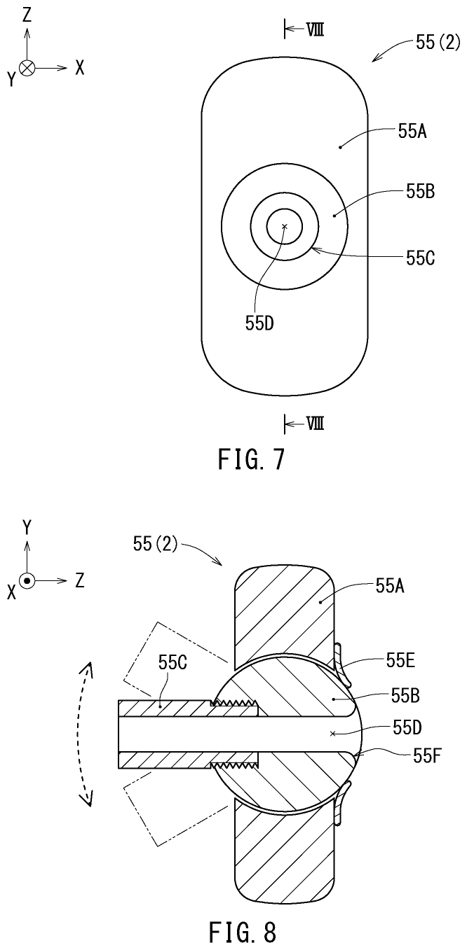

As shown in FIGS. 7 to 9, the ball joint 55 includes the base portion 55A, the ball portion 55B, and the tubular portion 55C. The base portion 55A, the ball portion 55B, and the tubular portion 55C are formed of a rigid material such as metal. As shown in FIGS. 8 and 9, the ball portion 55B is supported by the base portion 55A so as to allow relative rotation and angular displacement. An annular seal member 55E is provided so as to close a gap between the ball portion 55B and the base portion 55A.

As shown in FIG. 8, the tubular portion 55C is attached to the ball portion 55B. For example, the tubular portion 55C is screwed into and fixed to a threaded hole formed in the ball portion 55B. The tubular portion 55C and the ball portion 55B are provided with a through-hole 55D extending between the outside and the inside of the cover 50. The wires 51S and 36S (FIGS. 5 and 6) extend through the through-hole 55D.

As shown in FIG. 8, the ball portion 55B includes an edge portion 55F disposed at the end of the through-hole 55D opposite to the base connector 56. The edge portion 55F has a smooth arcuate profile so as not to damage the wires 51S and wires 36S.

As shown in FIG. 10, the base connector 56 is attached to the tubular portion 55C of the ball joint 55. The base connector 56 includes the base connector terminals 56A that are connected to the wires 51S and 36S. The base connector 56 has a serration 56B on its outer surface. The serration 56B is configured to mesh with a claw 57B formed in a fitting hole 57C of the conversion connector 57.

The conversion connector 57 has the fitting hole 57C to be fitted with the base connector 56, and has conversion connector terminals 57A to be connected to the base connector terminals 56A. The fitting hole 57C of the conversion connector 57 has the claw 57B configured to mesh with the serration 56B of the base connector 56. When the claw 57B engages with the serration 56B, the base connector 56 is prevented from being easily pulled out of the fitting hole 57C. Note that a serration may be formed on the conversion connector 57, and a claw may be provided on the base connector 56. In other words, one of the base connector 56 and the conversion connector 57 has a serration, and the other has a claw that engages with the serration. The base connector terminals 56A and the conversion connector terminals 57A are collectively referred to as connector terminals 4.

Various types of conversion connectors 57 are prepared according to the shape of the harness connector of the harness of the internal combustion engine system to be connected. FIG. 10 shows two types of conversion connectors, 57X and 57Y. The conversion connectors 57X and 57Y have identical fitting holes 57C and claws 57B. Thus, both conversion connectors 57X and 57Y can be fitted with the base connector 56. The conversion connectors 57X and 57Y have different connector shapes on the side of the conversion connector terminals 57A, depending on the shape of the harness connector of the harness of the internal combustion engine system.

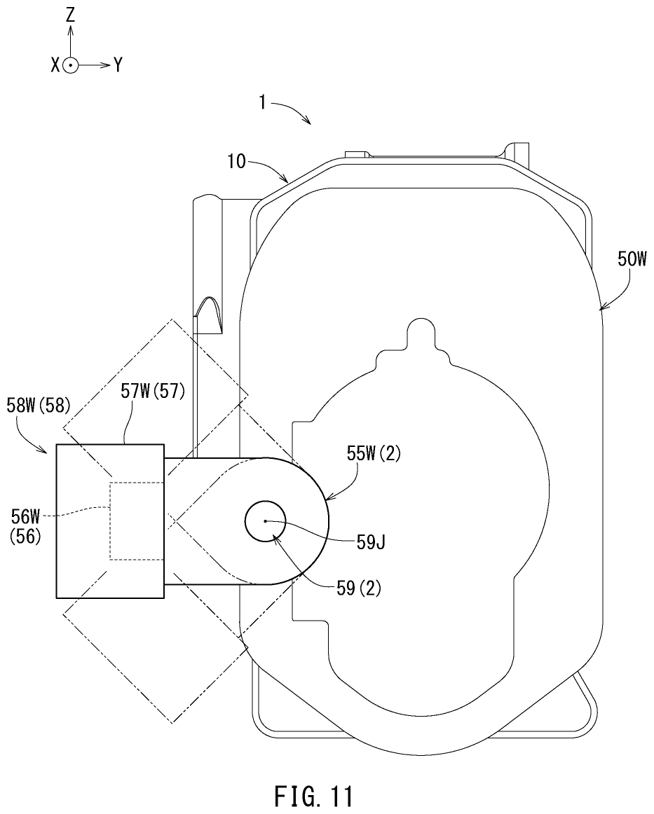

In the embodiment described above, the ball joint 55 is used as the direction-variable mechanism 2. However, the direction-variable mechanism 2 may take another form. In a case of a cover 50W shown in FIG. 11, the direction-variable mechanism 2 includes a pivot base 55W and a pivot shaft member 59. The pivot shaft member 59 rotatably supports the pivot base 55W such that the pivot base 55W can rotate around a pivot axis 59J. A base connector 56W is attached to the pivot base 55W. A conversion connector 57W is fitted to the base connector 56W. The conversion connector 57W may be replaced with various conversion connectors, such as the conversion connectors 57X and 57Y. The base connector 56W and the conversion connector 57W constitute a cover connector 58W. The wires connecting the connector terminals and the in-cover terminals extend through, for example, the interior of the pivot shaft member 59. The base connector 56W and the conversion connector 57W have the serration and the claw, respectively, in the same manner as the base connector 56 and the conversion connectors 57X and 57Y.

In accordance with the cover 50 of the throttle device 1 shown in FIGS. 1 to 10, since the cover connector 58 is attached to the cover 50 via the ball joint 55, the orientation and position of the cover connector 58 with respect to the throttle device 1 are variable. In accordance with the cover 50W shown in FIG. 11, since the cover connector 58W is attached to the cover 50W via the pivot base 55W, the orientation and position of the cover connector 58W with respect to the throttle device 1 can be varied. Accordingly, when the throttle device 1 is mounted on a vehicle or the like, the harness connector can be connected so as to avoid interference with devices adjacent to the throttle device 1.

Various conversion connectors 57 can be removably attached to the base connector 56 that is connected to the ball joint 55 (or the base connector 56W connected to the pivot base 55W). Therefore, various harness connectors can be connected to the throttle device 1. Furthermore, the base connector 56 or 56W and the conversion connector 57 have the serration 56B and the claw 57B, respectively, thereby facilitating attachment while preventing unintended removal.

The plurality of wires connecting the connector terminals 4 to the in-cover terminals 3 are routed through the through-hole formed in the ball joint 55 or the pivot shaft member 59. This arrangement prevents wire breakage and improves the appearance.

The covers 50 and 50W of the throttle device 1 disclosed herein are not limited to those described in the present embodiment. Various changes, additions, and deletions are possible without departing from the spirit of the present disclosure. For example, the cover connector 58 is not required to include the base connector 56 and the conversion connector 57. The shapes of the ball joint 55, the base connector 56, the conversion connector 57, and the pivot base 55W are not limited to those of the embodiment disclosed herein.

Furthermore, the direction-variable mechanism 2 is not limited to the ball joint 55 or the combination of the pivot base 55W and pivot shaft member 59. The serration 56B and the claw 57B may be omitted. The through-hole 55D of the ball joint 55 may be omitted. The covers 50 and 50W can be applied to throttle devices provided in intake passages of various internal combustion engine systems, including engines for marine vessels as well as non-vehicle applications.

The present disclosure can be carried out by various means. A first means is a cover for a throttle device provided in an intake passage of an internal combustion engine system. The cover includes a cover connector configured to be connected to a harness connector of a harness in the internal combustion engine system. The cover further includes a direction-variable mechanism connecting the cover connector to the cover. The direction-variable mechanism is configured to change the orientation of the cover connector with respect to the cover.

In accordance with the first means, since the cover connector is connected to the cover via the direction-variable mechanism, the orientation of the cover connector can be changed.

A second means is the cover of the first means, wherein the cover connector includes a base connector coupled to the direction-variable mechanism, and a conversion connector removably connected to the base connector. The conversion connector is selected from a plurality of conversion connectors having various shapes.

In accordance with the second means, since the conversion connector is selected from the plurality of conversion connectors having various shapes, the throttle device can be connected to various harness connectors of the internal combustion engine system by selecting an appropriate conversion connector.

A third means is the cover of the second means, wherein one of the base connector and the conversion connector has a serration, and the other has a claw. The serration and the claw are shaped to engage with each other so as to removably couple the base connector to the conversion connector.

In accordance with the third means, when coupling the base connector to the conversion connector, the engagement between the serration and the claw facilitates attachment while preventing unintended removal.

A fourth means is the cover of the first means, wherein the direction-variable mechanism is a ball joint.

In accordance with the fourth means, the direction-variable mechanism can be easily realized.

A fifth means is the cover of the fourth means, wherein the ball joint has a through hole formed therein extending between the exterior and the interior of the cover. The cover includes a plurality of terminals configured to be connected to electronic components of the throttle device. The plurality of terminals are arranged on an inner surface of the cover. The cover connector includes a plurality of connector terminals connected to the plurality of terminals via a plurality of wires, respectively. The plurality of wires are routed through the through hole of the ball joint.

In accordance with the fifth means, the wires connecting the base connector to the electronic components inside the throttle device are collectively routed through the through-hole of the ball joint. This arrangement prevents the wires from being exposed to the exterior of the throttle device, thereby avoiding wire breakage while improving the appearance of the throttle device.

What is claimed is:

1. A cover for a throttle device configured to be disposed in an intake passage of an internal combustion engine system, the cover comprising:
a cover connector configured to be connected to a harness connector of the internal combustion engine system; and
a direction-variable mechanism connecting the cover connector to the cover;
wherein the direction-variable mechanism is configured to change an orientation of the cover connector with respect to the cover.

2. The cover of claim 1, wherein the cover connector comprises:
a base connector coupled to the direction-variable mechanism; and
a conversion connector configured to be removably connected to the base connector;
wherein the conversion connector is one of a plurality of conversion connectors having different shapes.

3. The cover of claim 2, wherein one of the base connector and the conversion connector comprises a serration and the other comprises a claw;
wherein the serration and the claw are configured to engage with each other to removably connect the base connector to the conversion connector.

4. The cover of claim 1, wherein the direction-variable mechanism is a ball joint.

5. The cover of claim 4, further comprising a plurality of terminals configured to be connected to electronic components of the throttle device;
wherein the plurality of terminals are arranged on an inner surface of the cover;
wherein the cover connector includes a plurality of connector terminals connected to the plurality of terminals via a plurality of wires, respectively;
wherein the ball joint has a through hole formed therein extending between an exterior and an interior of the cover; and
wherein the plurality of wires are routed through the through hole of the ball joint.
